(19) United States
(12) Patent Application Publication
(10) Pub. No.: US 2010/0234980 A1
(43) Pub. Date: Sep. 16, 2010

(54) Multi-level parking lot and method

(76) Inventor: Armand Lapre, St-Hubert (CA)

Correspondence Address: Armand Lapre, # 106, 3591 Gouin E., Montreal, QC, H1H 5V7, CA

(21) Appl. No.: 12/701,534

(22) Filed: Feb. 6, 2010

Related U.S. Application Data
(60) Provisional application No. 61/202,574, filed on Mar. 13, 2009.

(51) Int. Cl. E04H 6/18; G06F 7/00; B66F 9/06

(52) U.S. Cl. 700/213; 414/261; 414/264; 187/237; 414/807

(57) ABSTRACT

A multi-level parking lot has a multi-level parking lot comprising a roadway disposed on aground surface. A plurality of parking containers each adapted to receive and store an automotive passenger vehicle. At least two of the parking containers being vertically stacked to form an inner stack of vertically stacked parking containers extending generally parallel to a first side of the roadway. At least two of the parking containers are vertically stacked to form an outer stack of vertically stacked columns of parking containers extending generally parallel to the first side of the roadway, and located between the first side of the roadway and the inner stack of vertically stacked parking containers. Each of the plurality of parking containers having an access aperture generally facing toward the first side of the roadway for passage of the vehicle therethrough.

This application claims priority based on provisional 61/202,574 filed Mar. 13, 2009

### FIELD OF THE INVENTION

The present invention relates generally to parking lots for vehicles, and is more particularly concerned with a compact multi-level parking lot and method therefor.

### BACKGROUND OF THE INVENTION

Parking lots having multiple floors or levels containing parking spaces in which vehicle may be parked are well known in the art. Typically, such parking lots have a plurality of parking spaces on each level with a ramp or roadway extending between each row of parking spaces on each level and extending between each level to allow passage of vehicles levels. Thus, vehicles may navigate between levels and within each level to find a parking space.

Unfortunately, the roadways between each level and between each horizontal strip of parking spaces on each level requires allocation of space within the parking lot, thus reducing the amount of space available for use as parking spaces. Further, navigation of vehicles through the roadways can become complex and cumbersome, especially when there are a large number of vehicles navigating through the parking lot at the same time.

Accordingly there is a need for an improved multi-level parking lot and method therefore.

### SUMMARY OF THE INVENTION

In view of the foregoing disadvantages inherent in the known devices now present in the prior art, the present invention, which will be described subsequently in greater detail, is to provide objects and advantages which are:

To provide for an improved multi-level parking lot to allow for use of less space for the parking lot.

Another advantage of the present invention is that less navigation of the multilevel parking lot is required, as compared to conventional multi-level parking lots.

Still another advantage of the present invention is that the multi-level parking lot and method of the current invention may provide increased security.

In a first aspect, the present invention provides a multi-level parking lot has a multi-level parking lot comprising a roadway disposed on aground surface. A plurality of parking containers each adapted to receive and store an automotive passenger vehicle. At least two of the parking containers being vertically stacked to form an inner stack of vertically stacked parking containers extending generally parallel to a first side of the roadway. At least two of the parking containers are vertically stacked to form an outer stack of vertically stacked columns of parking containers extending generally parallel to the first side of the roadway, and located between the first side of the roadway and the inner stack of vertically stacked parking containers. Each of the plurality of parking containers having an access aperture generally facing toward the first side of the roadway for passage of the vehicle therethrough. A vehicle carrying device adapted and configured for transporting the automotive passenger vehicle, wherein the vehicle carrying device includes a vertical displacement mechanism adapted to raise and lower the automotive passenger vehicle for inserting and removing through the access aperture of one of the parking containers; and a mechanism for moving the inner and outer stacks parallel to the roadway.

The mechanism for moving the inner and outer stacks comprises guide rails extending in a parallel fashion to the roadway; and wherein a plurality of inner and outer stacks of parking containers are provided; and wherein each of the inner stacks and each of the outer stacks are independently movably mounted on respective guide rails to allow linear displacement of each stack, and access to the access apertures of each stack for the vehicle carrying device to insert and remove the vehicles therethrough.

The lowermost parking container of each the inner and outer stack further includes a plurality of movement members on a lower outer surface thereof, and wherein each the guide rail includes a guide path, such that each of the movement members is adapted to slideably interact with each respective guide path of the guide rail, such that each the inner and outer stack is slideable along respective guide rails.

Guide rails extending along both sides of the roadway, thereby allowing for stacks of parking containers to be placed on either or both sides thereof.

Each the stack includes connection members placed upon at least one of the parking containers that are adapted to connect with the mechanism for moving the inner and outer stacks, such that a plurality of adjacent stacks can be moved at the same time.

Each of the parking containers includes connection members on opposite sides thereof that are adapted to connect with connection members of adjacent parking containers of adjacent stacks, thereby interconnecting the parking containers, such that a plurality of adjacent stacks can be moved more efficiently at the same time.

The connection members are chosen from a group of connection members including clips, clasps, hooks, and handles.

The guide rails further include motorized mechanisms adapted to provide movement of the inner and outer stacks along the guide rails.

A computer member for controlling the movement of each of the inner and outer stacks along the guide rails, the computer member adapted to keep track of empty containers, indicate in which container each vehicle is to be placed, and keep track of which vehicle is in which container; and wherein the computer member is also adapted to control the motorized guide rails such that the inner and outer stacks could automatically be displaced to provide access to a desired container.

The vehicle carrying device is a forklift; and wherein the vertical displacement mechanism is a hydraulic lift including at least one fork members adapted to be releasably insertable into corresponding slots of a vehicle carrying platform, such that the vehicle is carried, raised, and lowered on the forklift to a desired vertical level to insert and remove the platform and the vehicle into and out of a desired vehicle container.

The mechanism for moving the inner and outer stacks comprises a ceiling mounted displacement mechanism adapted to attach to a ceiling of a warehouse and move the stacks with respect thereto.

A multi-level parking lot having a method for parking vehicles comprising the steps of:

a) Forming at least one outer stack and at least one inner stack of vertically stacked parking containers adapted and configured for the storage of a vehicle in each respective container therein.
b) Identifying one of the at least one parking containers in which a vehicle is to be inserted.
c) Horizontally displacing at least one of the inner or outer stacks to provide access to an access aperture of the chosen parking container.
d) Transporting a vehicle with a vehicle carrying device along a roadway extending parallel to the stacks in which the chosen parking container is situated.
e) Positioning the vehicle adjacent to the access aperture of the chosen parking container of the vehicle using the vertical displacement mechanism of the vehicle carrying device.
f) Inserting the vehicle into the chosen parking container through the access aperture.

The method for parking vehicles further comprising the steps of:

a) Identifying one of the at least one parking containers in which a vehicle is to be removed.
b) Horizontally displacing at least one of the inner or outer stacks to provide access to an access aperture of the chosen parking container.
c) Positioning the vehicle carrying device adjacent and parallel to the stack in which the chosen parking container is situated.
d) Attaching the vehicle inside the chosen parking container to the vertical displacement mechanism of the vehicle carrying device.
e) Removing the vehicle of the chosen parking container through the access aperture.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 is a perspective view of an embodiment of a multi-level parking lot in accordance with the present invention;

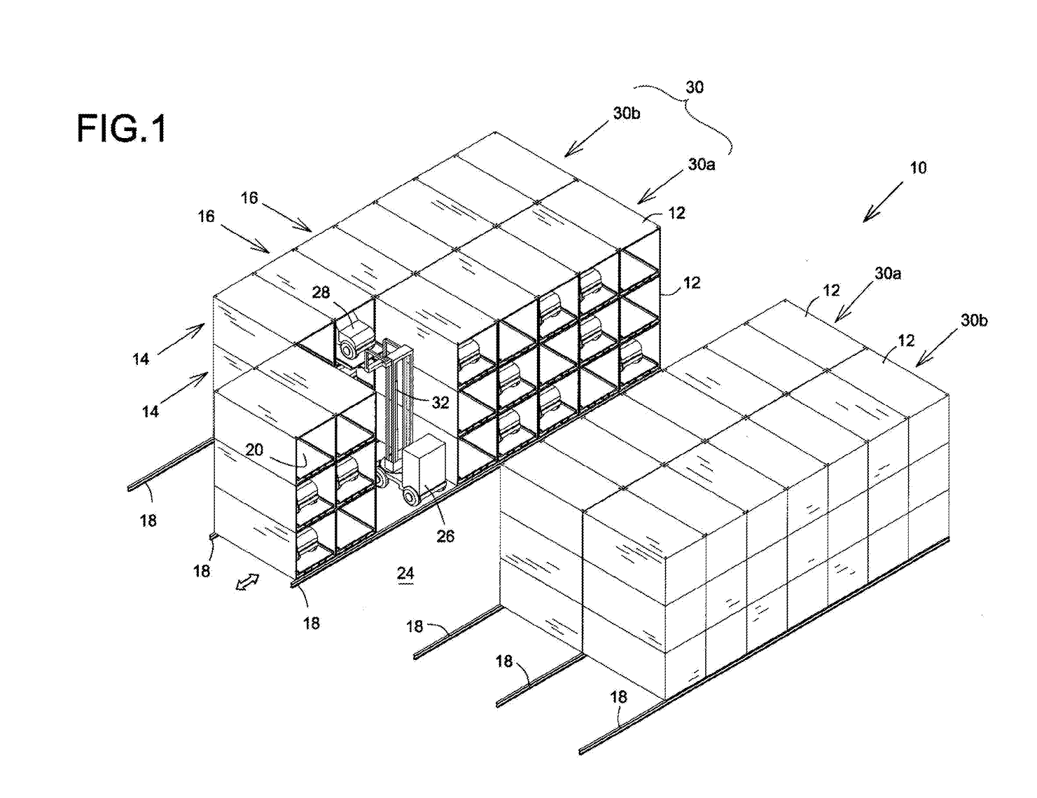

FIG. 2 is a top plan view of the multi-level parking lot shown in FIG. 1; and

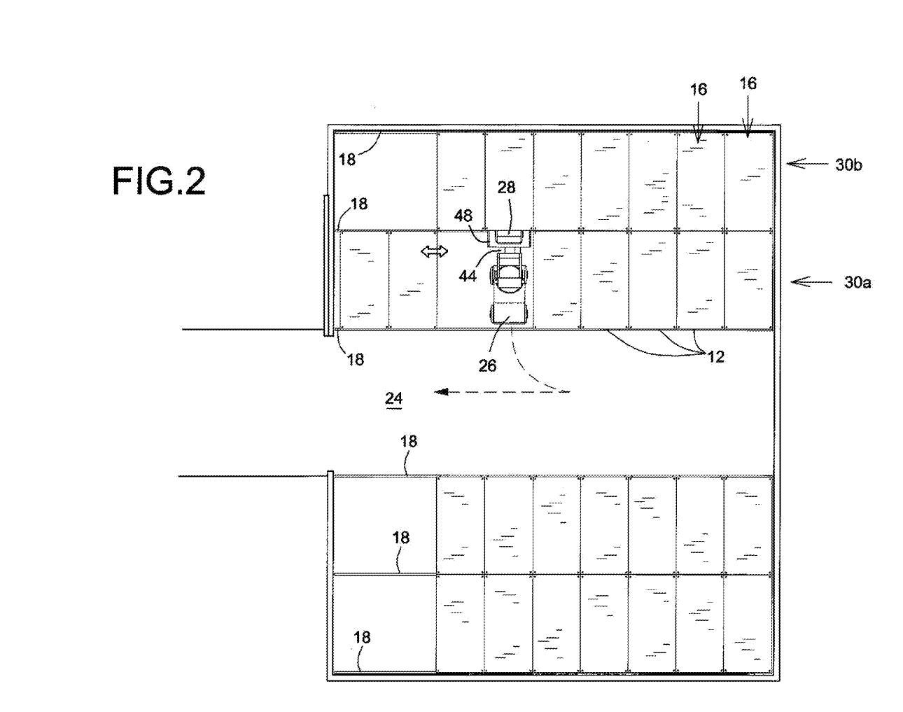

FIG. 3 is an enlarged perspective view of a parking container for the multilevel parking lot shown in FIG. 1.

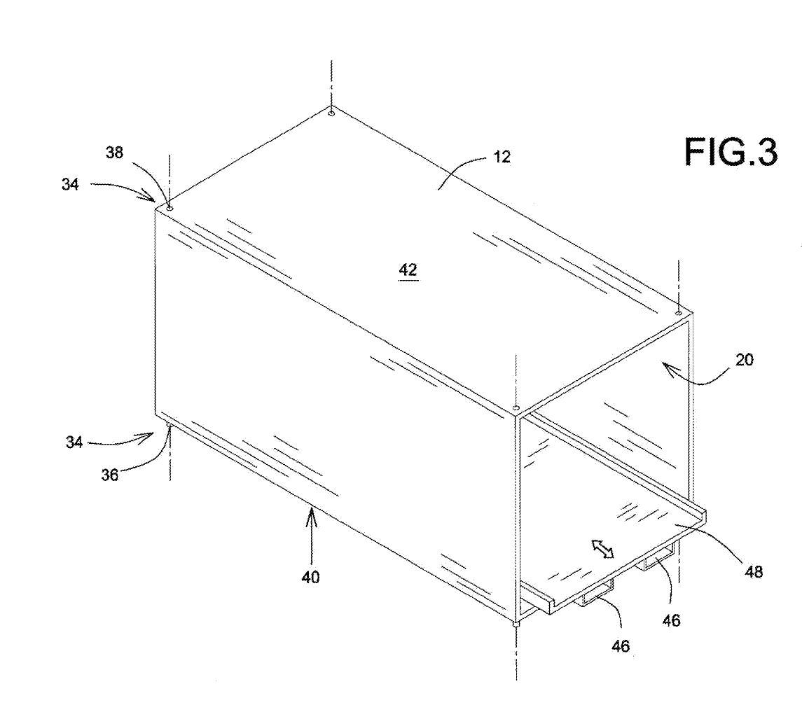

### DETAILED DESCRIPTION OF THE PREFERRED EMBODIMENTS

A multi-level parking lot (10) has a roadway (24) disposed on aground surface. A plurality of parking containers (12) each adapted to receive and store an automotive passenger vehicle (28). At least two of the parking containers (12) being vertically stacked to form an inner stack (30b) of vertically stacked parking containers (12) extending generally parallel to a first side of the roadway (24). At least two of the parking containers (12) are vertically stacked to form an outer stack (30a) of vertically stacked columns (16) of parking containers (12) extending generally parallel to the first side of the roadway (24), and located between the first side of the roadway (24) and the inner stack (30b) of vertically stacked parking containers (12). Each of the plurality of parking containers (12) having an access aperture (20) generally facing toward the first side of the roadway (24) for passage of the vehicle (28) therethrough. A vehicle carrying device (26) adapted and configured for transporting the automotive passenger vehicle (28), wherein the vehicle carrying device (26) includes a vertical displacement mechanism (32) adapted to raise and lower the automotive passenger vehicle (28) for inserting and removing through the access aperture (20) of one of the parking containers; and a mechanism for moving the inner and outer stacks (30) parallel to the roadway (24).

The mechanism for moving the outer and inner stacks (30a, 30b) comprises guide rails (18) extending in a parallel fashion to the roadway (24) and wherein a plurality of outer and inner stacks (30a, 30b) of parking containers (12) are provided. Each of the inner stacks (30b) and each of the outer stacks (30a) are independently movably mounted on respective guide rails (18) to allow linear displacement of each stack (30), and access to the access apertures (20) of each stack (30) for the vehicle carrying device (26) to insert and remove the vehicles (28) therethrough.

The lowermost parking container (12) of each the outer and inner stacks (30a, 30b) further includes a plurality of movement members on a lower outer surface thereof, and wherein each the guide rail (18) includes a guide path, such that each of the movement members is adapted to slideably interact with each respective guide path of the guide rail (18), such that each the outer and inner stack (30a, 30b) is slideable along respective guide rails (18).

Guide rails (18) extending along both sides of the roadway (24), thereby allowing for stacks (30) of parking containers (12) to be placed on either or both sides thereof.

Each the stack (30) includes connection members placed upon at least one of the parking containers (12) that are adapted to connect with the mechanism for moving the outer and inner stacks (30a, 30b) such that a plurality of adjacent stacks (30) can be moved at the same time.

Each of the parking containers (12) includes connection members (36) on opposite sides thereof that are adapted to connect with connection members (36) of adjacent parking containers (12) of adjacent stacks (30), thereby interconnecting the parking containers (12), such that a plurality of adjacent stacks (30) can be moved more efficiently at the same time.

The connection members (36) are chosen from a group of connection members (36) including clips, clasps, hooks, and handles.

The guide rails (18) further include motorized mechanisms adapted to provide movement of the outer and inner stacks (30a, 30b) along the guide rails (18).

A computer member for controlling the movement of each of the outer and inner stacks (30a, 30b) along the guide rails (18), the computer member adapted to keep track of empty containers (12), indicate in which container (12) each vehicle (28) is to be placed, and keep track of which vehicle (28) is in which container (12). The computer member is also adapted to control the motorized guide rails (18) such that the outer and inner stacks (30a, 30b) could automatically be displaced to provide access to a desired container (12).

The vehicle carrying device is preferably a hydraulic forklift (32) includes at least one fork member (44) adapted to be releasably insertable into corresponding slots (46) of a vehicle carrying platform (48), such that the vehicle (28) is carried, raised, and lowered on the forklift (32) to a desired vertical level to insert and remove the platform (48) and the vehicle (28) into and out of a desired vehicle container (12.

The mechanism for moving the outer and inner stacks (30a, 30b) comprises a ceiling mounted displacement mechanism adapted to attach to a ceiling of a warehouse and move the stacks (30) with respect thereto.

The multi-level parking lot (10) has a method for parking vehicles (28) comprising the steps of:

a) Forming at least one outer stack (30a) and at least one inner stack (30b) of vertically stacked parking containers (12) adapted and configured for the storage of a vehicle (28) in each respective container (12) therein.
b) Identifying one of the at least one parking containers (12) in which a vehicle (28) is to be inserted.
c) Horizontally displacing at least one of the outer or inner stacks (30a, 30b) to provide access to an access aperture (20) of the chosen parking container (12).
d) Transporting a vehicle (28) with a vehicle carrying device (26) along a roadway (24) extending parallel to the stacks (30) in which the chosen parking container (12) is situated.
e) Positioning the vehicle (28) adjacent to the access aperture (20) of the chosen parking container (12) of the vehicle (28) using the vertical displacement mechanism (32) of the vehicle carrying device (26).
f) Inserting the vehicle (28) into the chosen parking container (12) through the access aperture (20.

The method for parking vehicles (28) further comprising the steps of:

a) Identifying one of the at least one parking containers (12) in which a vehicle (28) is to be removed.
b) Horizontally displacing at least one of the outer or inner stacks (30a, 30b) to provide access to an access aperture (20) of the chosen parking container (12).
c) Positioning the vehicle carrying device (26) adjacent and parallel to the stack (30) in which the chosen parking container (12) is situated.
d) Attaching the vehicle (28) inside the chosen parking container (12) to the vertical displacement mechanism (32) of the vehicle carrying device (26).
e) Removing the vehicle (28) of the chosen parking container (12) through the access aperture (20).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A multi-level parking lot comprising a roadway disposed on a ground surface; a plurality of parking containers each adapted to receive and store an automotive passenger vehicle; at least two of said parking containers being vertically stacked to form an inner stack of vertically stacked parking containers extending generally parallel to a first side of said roadway; at least two of said parking containers being vertically stacked to form an outer stack of vertically stacked columns of parking containers extending generally parallel to said first side of said roadway, and located between the first side of said roadway and said inner stack of vertically stacked parking containers; each of said plurality of parking containers having an access aperture generally facing toward the first side of said roadway for passage of said vehicle therethrough; a vehicle carrying device adapted and configured for transporting said automotive passenger vehicle, wherein said vehicle carrying device includes a vertical displacement mechanism adapted to raise and lower said automotive passenger vehicle for inserting and removing through said access aperture of one of said parking containers; and a mechanism for moving said inner and outer stacks parallel to said roadway.

2. The multi-level parking lot of claim 1, wherein said mechanism for moving said inner and outer stacks comprises guide rails extending in a parallel fashion to said roadway; and wherein a plurality of inner and outer stacks of parking containers are provided; and wherein each of said inner stacks and each of said outer stacks are independently movably mounted on respective guide rails to allow linear displacement of each stack, and access to said access apertures of each stack for said vehicle carrying device to insert and remove said vehicles therethrough.

3. The multi-level parking lot of claim 2, wherein the lowermost parking container of each said inner and outer stack further includes a plurality of movement members on a lower outer surface thereof; and wherein each said guide rail includes a guide path, such that each of said movement members is adapted to slideably interact with each respective guide path of said guide rail, such that each said inner and outer stack is slideable along respective guide rails.

4. The multi-level parking lot of claim 2, further comprising guide rails extending along both sides of said roadway, thereby allowing for stacks of parking containers to be placed on either or both sides thereof.

5. The multi-level parking lot of claim 1, wherein each said stack includes connection members placed upon at least one of said parking containers that are adapted to connect with said mechanism for moving said inner and outer stacks, such that a plurality of adjacent stacks can be moved at the same time.

6. The multi-level parking lot of claim 5, wherein each of said parking containers includes connection members on opposite sides thereof that are adapted to connect with connection members of adjacent parking containers of adjacent stacks, thereby interconnecting said parking containers, such that a plurality of adjacent stacks can be moved more efficiently at the same time.

7. The multi-level parking lot of claim 6, wherein said connection members are chosen from a group of connection members including clips, clasps, hooks, and handles.

8. The multi-level parking lot of claim 2, wherein said guide rails further include motorized mechanisms adapted to provide movement of said inner and outer stacks along said guide rails.

9. The multi-level parking lot of claim 8, further comprising a computer member for controlling the movement of each of said inner and outer stacks along said guide rails, said computer member adapted to keep track of empty containers, indicate in which container each vehicle is to be placed, and keep track of which vehicle is in which container; and wherein said computer member is also adapted to control said motorized guide rails such that said inner and outer stacks could automatically be displaced to provide access to a desired container.

10. The multi-level parking lot of claim 1, wherein said vehicle carrying device is a forklift; and wherein said vertical displacement mechanism is a hydraulic lift including at least one fork members adapted to be releasably insertable into corresponding slots of a vehicle carrying platform, such that said vehicle is carried, raised, and lowered on said forklift to a desired vertical level to insert and remove said platform and said vehicle into and out of a desired vehicle container.

11. The multi-level parking lot of claim 1, wherein said mechanism for moving said inner and outer stacks comprises a ceiling mounted displacement mechanism adapted to attach to a ceiling of a warehouse and move said stacks with respect thereto.

12. A method for parking vehicles in a multi-level parking lot, the method comprising the steps of:
a. forming at least one outer stack and at least one inner stack of vertically stacked parking containers adapted and configured for the storage of a vehicle in each respective container therein;
b. identifying one of said at least one parking containers in which a vehicle is to be inserted;
c. horizontally displacing at least one of said inner or outer stacks to provide access to an access aperture of the chosen parking container;
d. transporting a vehicle with a vehicle carrying device along a roadway extending parallel to said stacks in which said chosen parking container is situated;
e. positioning said vehicle adjacent to said access aperture of said chosen parking container of the vehicle using said vertical displacement mechanism of the vehicle carrying device; and
f. inserting said vehicle into said chosen parking container through said access aperture.

13. The method for parking vehicles in a multi-level parking lot of claim 12, further comprising the steps of:
a. identifying one of said at least one parking containers in which a vehicle is to be removed;
b. horizontally displacing at least one of said inner or outer stacks to provide access to an access aperture of the chosen parking container;
c. positioning said vehicle carrying device adjacent and parallel to the stack in which said chosen parking container is situated;
d. attaching the vehicle inside said chosen parking container to said vertical displacement mechanism of the vehicle carrying device; and
e. removing said vehicle of said chosen parking container through said access aperture.
